(19) United States
(12) Patent Application Publication
(10) Pub. No.: US 2013/0090769 A1
(43) Pub. Date: Apr. 11, 2013

(54) METHODS OF OPERATING AN HVAC SYSTEM, AN HVAC SYSTEM AND A CONTROLLER THEREFOR EMPLOYING A SELF-CHECK SCHEME AND PREDETERMINED OPERATING PROCEDURES ASSOCIATED WITH OPERATING UNITS OF AN HVAC SYSTEM

(71) Applicants: Justin McKie, Frisco, TX (US); Eric Perez, Hickory Creek, TX (US); Greg Thomas, McKinney, TX (US)

(72) Inventors: Justin McKie, Frisco, TX (US); Eric Perez, Hickory Creek, TX (US); Greg Thomas, McKinney, TX (US)

(73) Assignee: Lennox Industries Inc., Richardson, TX (US)

(21) Appl. No.: 13/267,441

(22) Filed: Oct. 6, 2011

(51) Int. Cl. G05D 23/19

(52) U.S. Cl. 700/277

(57) ABSTRACT

In one aspect, a controller for an HVAC system is disclosed. In one embodiment, the controller includes: (1) an interface configured to receive feedback data from operating units of the HVAC system and transmit control data to the operating units, (2) an operation verifier configured to determine an individual operating status for each one of the operating units based on the feedback data and (3) a mode setter configured to distinctly operate each one in a predetermined operating procedure based on the determined operating status for each one.

### CROSS-REFERENCE TO RELATED APPLICATION

This application is related to U.S. application Ser. No. ______ [LENX-100076] to Justin McKie et al. and U.S. application Ser. No. ______ [LENX-100094] (the 'xxx application) to Justin McKie, et al., both filed on even date herewith, and both commonly assigned with this application and incorporated herein by reference.

### TECHNICAL FIELD

This application is directed, in general, to climate control systems, and, more specifically, to operating such systems.

### BACKGROUND

Heating, ventilating and air conditioning (HVAC) systems can be used to regulate the environment within an enclosed space. Typically, an air blower is used to pull air from the enclosed space into the HVAC system through ducts and push the air back into the enclosed space through additional ducts after conditioning the air (e.g., heating, cooling or dehumidifying the air). Various types of HVAC systems may be used to provide conditioned air for enclosed spaces. For example, some HVAC units are located on the rooftop of a commercial building. These so-called rooftop units, or RTUs, typically include one or more blowers and heat exchangers to heat and/or cool the building, and baffles to control the flow of air within the RTU. Some RTUs also include an air-side economizer that allows to selectively provide fresh outside air to the RTU or to recirculate exhaust air from the building back through the RTU to be cooled or heated again.

When the enthalpy of the fresh air is less than the enthalpy of the recirculated air, conditioning the fresh air may be more energy-efficient than conditioning the recirculated air. In this case the economizer may exhaust a portion of the stale air and replace the vented air with outside air. When the outside air is both sufficiently cool and sufficiently dry it may be possible that no additional conditioning of the outside air is needed. In this case the economizer may draw a sufficient quantity of outside air into the building to provide all the needed cooling. In some installations an energy recovery ventilator (ERV) may be used to pre-condition the fresh air demanded by the RTU. The ERV may include, e.g., an enthalpy wheel to transfer heat and/or humidity between an incoming fresh air stream and an outgoing exhaust air stream.

Thus, RTUs and HVAC systems in general have been improved with various options, such as an ERV, to provide higher efficiency and better comfort. Accordingly, HVAC systems have typically become more complex resulting in a cost increase for installation and service.

### SUMMARY

In one aspect, a controller for an HVAC system is disclosed. In one embodiment, the controller includes: (1) an interface configured to receive feedback data from operating units of the HVAC system and transmit control data to the operating units, (2) an operation verifier configured to determine an individual operating status for each one of the operating units based on the feedback data and (3) a mode setter configured to distinctly operate the each one in a predetermined operating procedure based on the determined operating status for the each one.

In another aspect, the disclosure provides a computer-usable medium having non-transitory computer readable instructions stored thereon for execution by a processor to perform a method for operating a HVAC. In one embodiment, the method performed includes: (1) receiving feedback data from operating units of the HVAC system, (2) determining an individual operating status for each one of the operating units based on the feedback data and (3) distinctly operating the each one in a predetermined operating procedure based on the determined operating status for the each one.

In yet another aspect, an HVAC system is disclosed. In one embodiment, the HVAC system includes: (1) sensors configured to indicate operating conditions of the HVAC system, (2) multiple components configured to condition and move air through the HVAC system and (3) a controller having (3A) an interface configured to receive feedback data from the sensors and the multiple components and transmit control data to the multiple components, (3B) an operation verifier configured to determine an individual operating status for each one of the sensors and the multiple components based on the feedback data and (3C) a mode setter configured to distinctly operate the each one in a predetermined operating procedure based on each the determined operating status.

In still another aspect, another controller for an HVAC system. In one embodiment, this controller includes: (1) an interface configured to receive feedback data from operating units of the HVAC system and transmit control data to the operating units and (2) a mode setter configured to individually operate at least one of the operating units in a predetermined operating procedure based on the feedback data, wherein each the predetermined operating procedure is an operating process specifically configured to operate the at least one at a reduced capacity.

In still yet another aspect, another computer-usable medium. In one embodiment, the computer-usable medium is employed to perform a method for operating an HVAC system, including: (1) receiving feedback data from operating units of the HVAC system and (2) individually operating at least one of the operating units in a predetermined operating procedure based on the feedback data, wherein each the predetermined operating procedure is an operating process specifically configured to operate the at least one in a limited capacity.

Yet in an another aspect, the disclosure provides another HVAC system. In one embodiment, the HVAC system includes: (1) sensors configured to indicate operating conditions of the HVAC system, (2) multiple components configured to condition and move air through the HVAC system and (3) a controller having (3A) an interface configured to receive feedback data from operating units of the HVAC system and transmit control data to the operating units and (3B) a mode setter configured to individually operate at least one of the operating units in a predetermined operating procedure based on the feedback data, wherein each the predetermined operating procedure is a predetermined operating process specifically configured to operate the at least one in a limited capacity.

### BRIEF DESCRIPTION

Reference is now made to the following descriptions taken in conjunction with the accompanying drawings, in which:

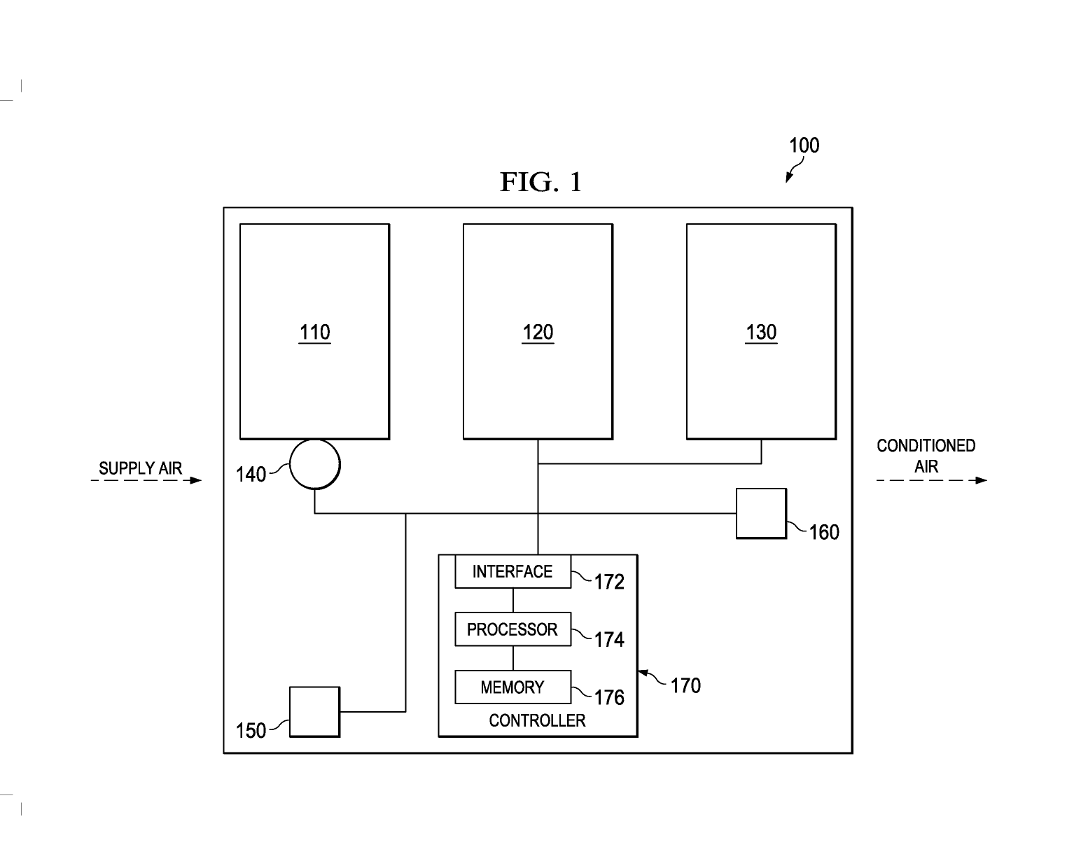

FIG. 1 illustrates a block diagram of an embodiment of an HVAC system constructed according to the principles of the disclosure;

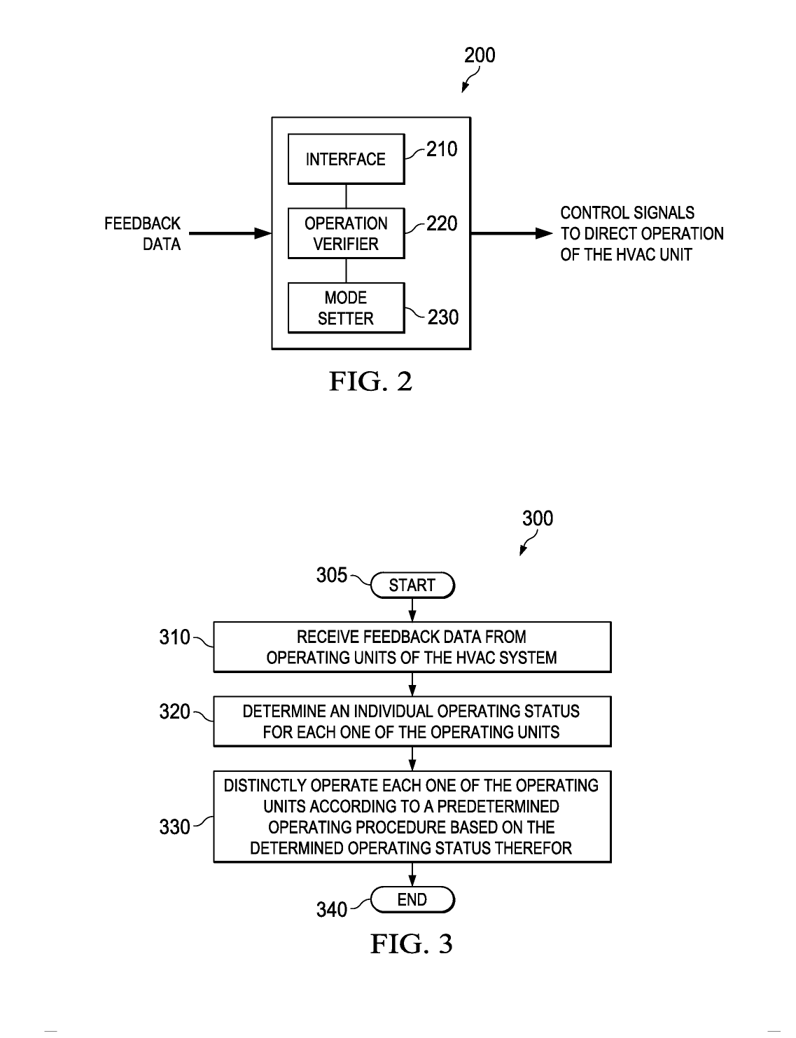

FIG. 2 illustrates a block diagram of an embodiment of a controller constructed according to the principles of the disclosure;

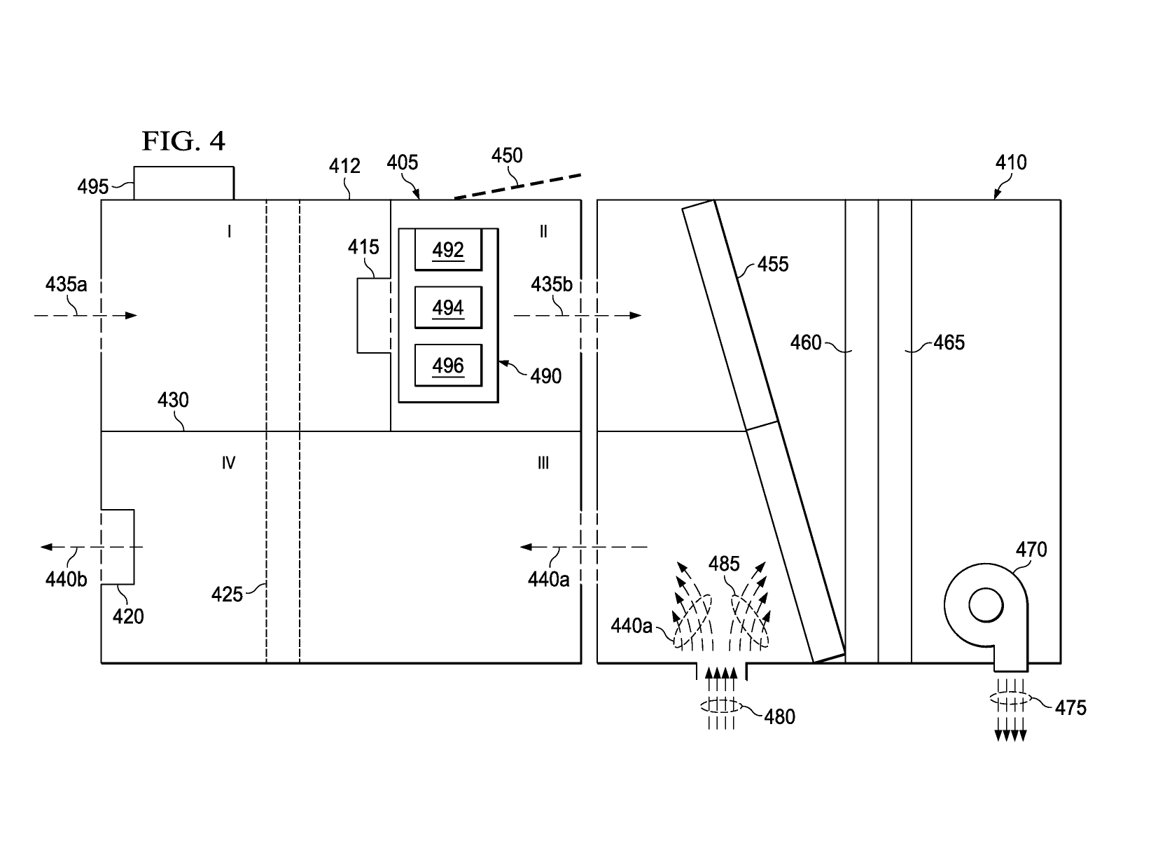

FIG. 3 illustrates a flow diagram of an embodiment of a method of operating an HVAC system carried out according to the principles of the disclosure;

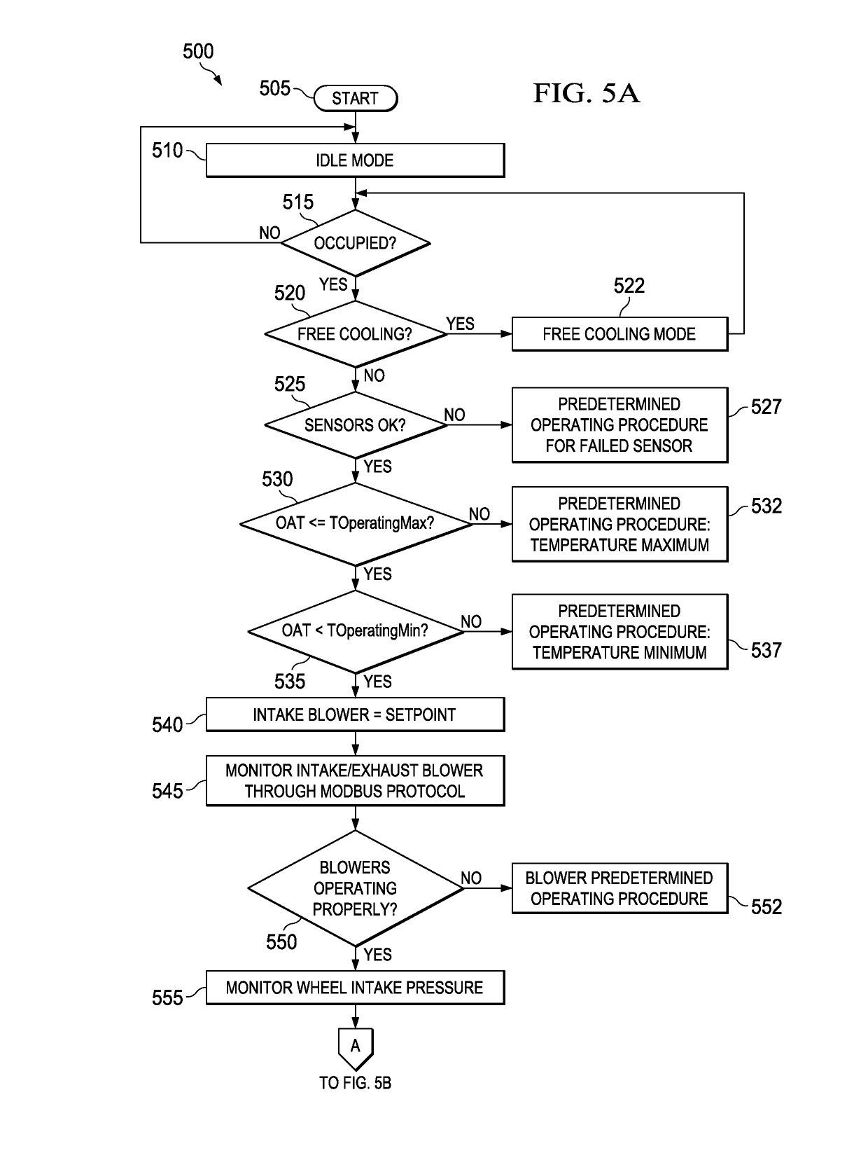

FIG. 4 illustrates a block diagram of an embodiment of an HVAC system, including a RTU and ERV, constructed according to principles of the disclosure;

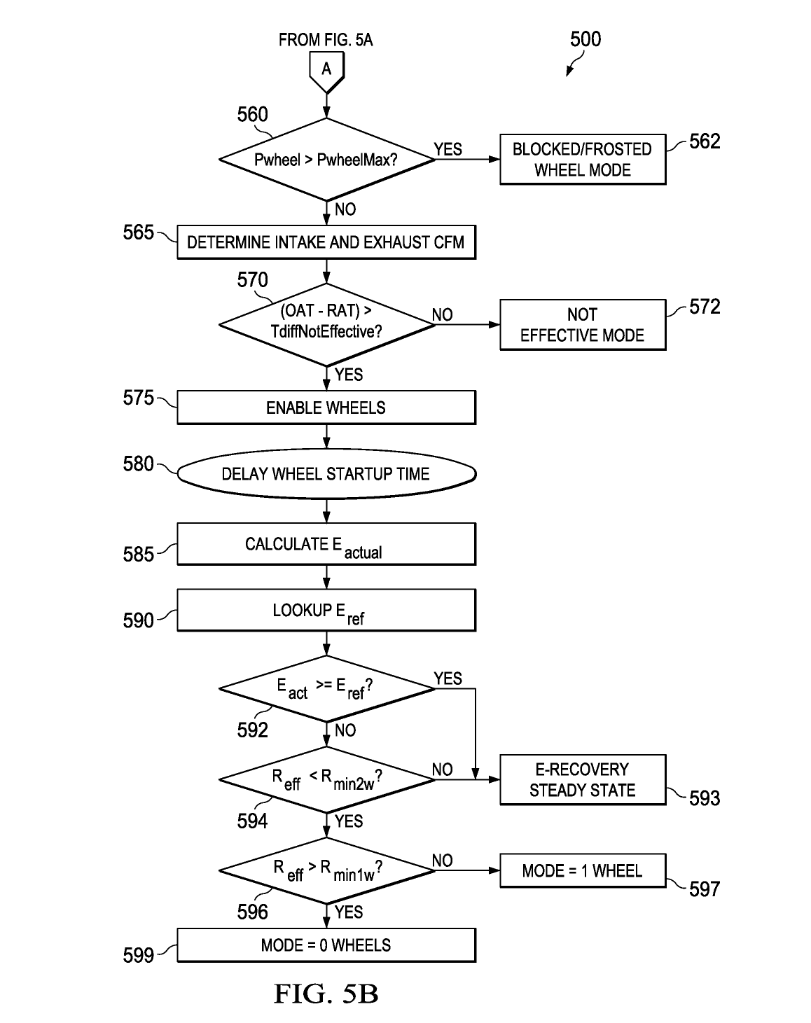

FIG. 5A and FIG. 5B illustrate a flow diagram of an embodiment of a method of operating an HVAC system having an ERV carried out according to the principles of the disclosure;

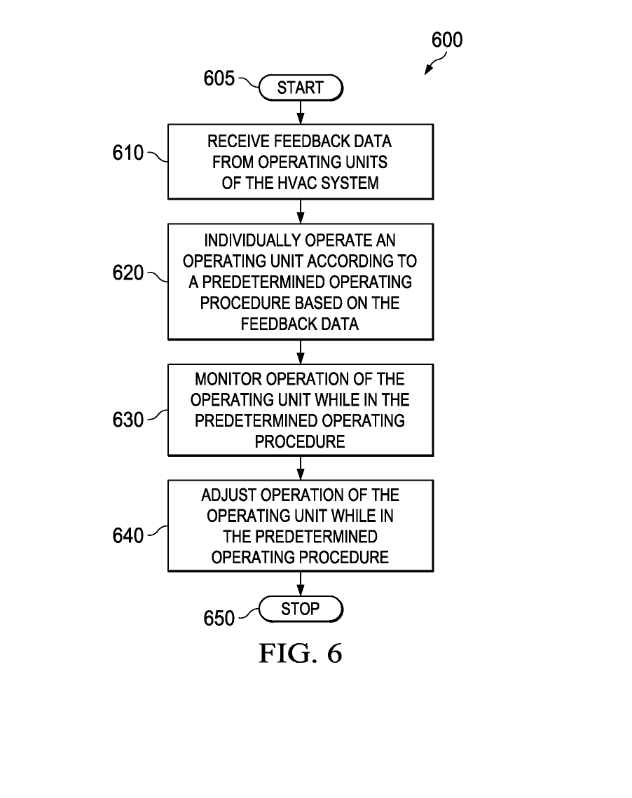

FIG. 6 illustrates a flow diagram of another embodiment of a method of operating an HVAC system carried out according to the principles of the disclosure;

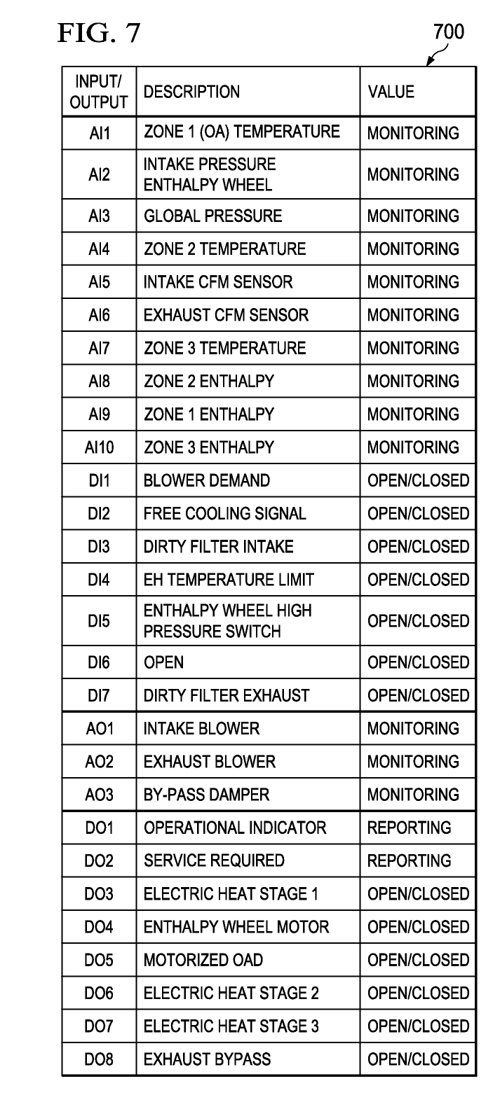

FIG. 7 illustrates an embodiment of a Table 700 including the various feedback data that is communicated by a controller constructed according to the principles of the disclosure; and

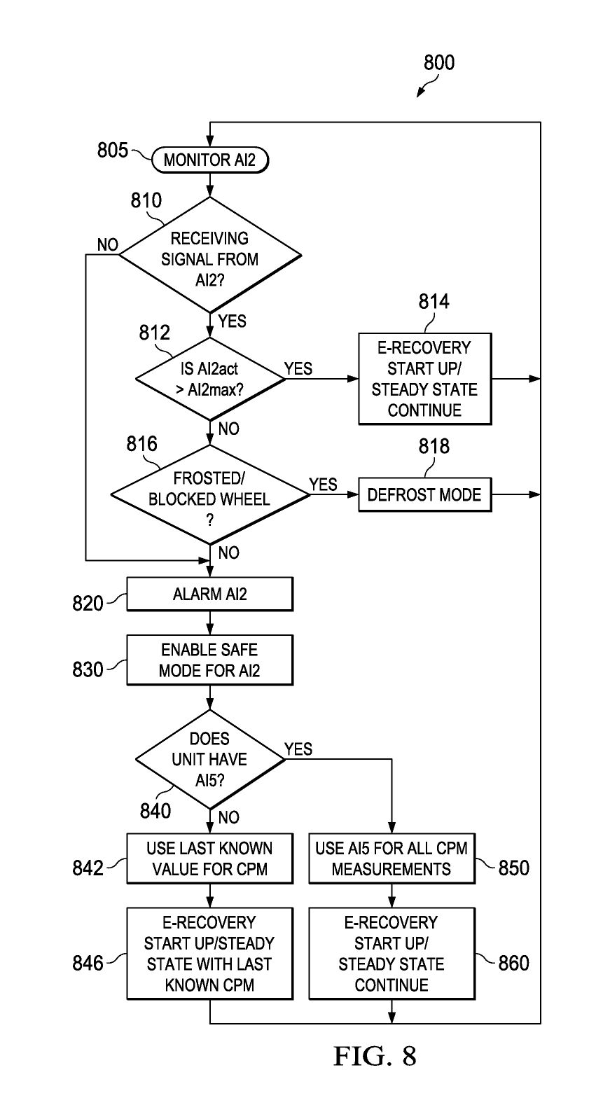

FIG. 8 illustrates a flow diagram of an embodiment of a method 800 of operating an HVAC system according to a predetermined operating procedure carried out according to the principles of the disclosure.

### DETAILED DESCRIPTION

In addition to increased installation and service costs associated with system improvements, clients want to ensure that the various options that have been installed at a site are working properly to take full advantage of their investment. To ensure proper operation, additional sensors are typically installed with an HVAC system to verify correct operation of the components. Thus, the complexity of HVAC systems is increased even more. Not knowing if the sensors or components are operating properly can result in nuisance calls, improper unit operation and component replacement that may or may not be needed. Additionally, not knowing the actual operating status of a component may result in a component being unnecessarily turned-off to prevent damage to it or other components of the HVAC system. Thus, clients may not receive the benefit of their investment.

The disclosure provides a self-check scheme that verifies operating units of an HVAC system are operating properly. Accordingly, the disclosed HVAC systems can self-diagnose problems for their operating units, determine the severity of diagnosed problems and decide what actions need to be taken in response to the diagnosed problems and the severity level thereof. The disclosed scheme can determine the individual operating status for a particular operating unit based on feedback data received from that particular operating unit and/or feedback data from multiple of the operating units. Thus, a particular operating status for individual operating units can be determined and then the individual operating units can be distinctly operated according to predetermined operating procedures based thereon. As such, one operating unit may be operated according to one predetermined operating procedure while another operating unit is operated based on another predetermined operating procedure. The predetermined operating procedures for each particular operating unit may be distinct and based on a set of operating parameters. The operating parameters may be specific for a particular operating unit.

The predetermined operating procedures, which may be referred to as safe modes in some embodiments, are tailored for specific operating units of the HVAC system. As such individual operating units of an HVAC system can have a predetermined operating procedure that is specifically designed for that operating unit. Each predetermined operating procedure is designed for and assigned to a specific operating unit and includes a predetermined logic process to control the operation of an operating unit or units. In a predetermined operating procedure, operating units are not necessarily disabled or turned-off, but different operating modes may be employed. For example, an HVAC system or a portion thereof may be operated at a reduced capacity in a predetermined operating procedure. Additionally, the operating limits used to initiate alarms may be altered to increase protection for an operating unit or units of an

HVAC system in a predetermined operating procedure. Additional alarm limits may also be employed in a predetermined operating procedure to trigger different modes of operation. By employing the logic process of the predetermined operating procedures, HVAC equipment does not have to be turned-off. As such, clients can still receive at least a portion of the benefit associated with their investment.

The predetermined operating procedure for an operating unit may be activated when an operating unit either fails to operate properly, possibly after a predetermined number of tries, or operates outside of a set of established operating parameters for that operating unit. A controller of the HVAC system may determine if the operating unit is not operating as desired based on feedback data and activate a predetermined operating procedure when appropriate.

Once in a predetermined operating procedure, the disclosed controller may continue to monitor a designated operating unit for proper operation and operate at a limited capability until the operating unit begins working properly or is fixed by a technician. In some embodiments, a predetermined operating procedure may not be entered until a defined amount of time even after a triggering event has been detected. For example, even if failure of a sensor has been detected, the associated predetermined operating procedure may not be entered for a set time (e.g., five minutes). During the set time, the sensor is continually monitored to see if the trouble clears. If a problem is deemed extreme enough, the controller may completely shut down an operating unit or even the HVAC system to prevent damage to the particular operating unit, other operating units or the HVAC system as a whole.

As disclosed herein, feedback data associated with one operating unit or multiple operating units of an HVAC system may trigger a predetermined operating procedure. An HVAC system, therefore, can still function even if some operating units are not operating as designed or desired. Thus, instead of disabling a complete HVAC system due to one or some operating units operating improperly, the disclosure provides predetermined operating procedures that maintain operation of the HVAC system and still protect it from damage. The predetermined operating procedure, therefore, associated with a particular operating unit may be distinct and based on a set of operating parameters established specifically for it. Accordingly, component and/or sensor malfunctions of an HVAC system may be individually addressed and contained.

The self-check scheme and predetermined operating procedures may be implemented in a controller of a system, such as an HVAC system. Typically, each HVAC system includes a designated controller that is configured to direct the operation thereof. A HVAC controller may be one or more electric circuit boards including at least one micro-processor or micro-controller integrated circuit. The HVAC controller also includes the support circuitry for power, signal conditioning, and associated peripheral devices. In addition to a processor, the HVAC controller may include a memory having a program or series of operating instruction (i.e., firmware or software) that executes in such a way as to implement at least some of the features of the self-check scheme and the predetermined operating procedures described herein when initiated by the processor. The controller, or the processor of the controller, may be configured to provide control functionality beyond the scope of the present disclosure.

Operating units of an HVAC system are operating members of the HVAC system that perform a designated function. Operating units include, for example, sensors and components of an HVAC system. In one embodiment, an ERV is disclosed that has operating units including components, such as an intake blower and an enthalpy wheel, and sensors, such as a pressure sensor.

FIG. 1 illustrates a block diagram of an embodiment of an HVAC system 100 constructed according to the principles of the disclosure. The HVAC system 100 is configured to receive supply air and process the air to provide conditioned air for a structure such as a building. The supply air may be recirculated air. The HVAC system 100 may be a residential or commercial unit. The HVAC system 100 may be a RTU or part of a RTU for a commercial installation. For example, the HVAC system 100 may be an ERV associated with an RTU.

The HVAC system 100 includes multiple operating units and a controller 170. Operating units 110, 120 and 130 are components that move and/or condition air for a structure. For example, in one embodiment the HVAC system 100 is an ERV and operating unit 110 is an intake blower, operating unit 120 is an enthalpy wheel and operating unit 130 is an exhaust blower.

Operating units 140, 150 and 160 are sensors that are used to monitor the operation of the HVAC system 100. For example, operating unit 140 may be a sensor used to detect the operating speed of an intake blower, operating unit 110. Sensors 150 and 160 may be pressure sensors that are used to determine the air pressure in different locations within the HVAC system 100.

The controller 170 is configured to direct the operation of the HVAC system 100. As such, the controller 170 is configured to generate control signals that are transmitted to the various operating units (e.g., components) to direct the operation thereof. The controller 170 may generate the control signals in response to feedback data that is received from the various sensors and/or components (i.e., operating units) of the HVAC system 100. The controller 170 includes an interface 172 that is configured to receive and transmit the feedback data and control signals. The interface 172 may be a conventional interface that is used to communicate (i.e., receive and transmit) data for a controller, such as a microcontroller. The controller 170 may also include additional components typically included within a controller for a HVAC unit, such as a power supply or power port.

The controller 170 also includes a processor 174 and a memory 176. The memory 176 may be a conventional memory typically located within a microcontroller that is constructed to store data and computer programs. The memory 176 may store operating instructions to direct the operation of the processor 174 when initiated thereby. The operating instructions may correspond to algorithms that provide the functionality of the self-check schemes and the predetermined operating procedures disclosed herein. The processor 174 may be a conventional processor such as a microprocessor. The interface 172, processor 174 and memory 176 may be coupled together via conventional means to communicate information.

The controller 170 is configured to provide a self-check scheme for the HVAC system 100 that may be employed to determine when to activate predetermined operating procedures based on different operating units. As such, the controller 170 is configured to receive feedback data from the operating units 110, 120, 130, 140, 150 and 160, determine an individual operating status for each one of the operating units based on the feedback data and distinctly operate each one according to a predetermined operating procedure based on the determined operating status for each one. The controller 170 may generate and transmit control signals to the operating units to distinctly operate each particular operating unit according to the determined operating mode. The controller 170 distinctly operates an operating unit by individually directing the operation of a particular unit according to the selected predetermined operating procedure. Thus, instead of directing the operation of the HVAC system 100 as a whole, the controller 170 can independently direct the operation of each operating unit based on the predetermined operating procedures. Accordingly, one or more of the operating units may be operated at a reduced capacity in response to the feedback data while the remaining operating units are operated at a normal operating status. The reduced capacities may vary for the different operating units and can be determined via comparison to predetermined sets of operating parameters. In addition to a self-check scheme and the predetermined operating procedures, the controller 170 may be configured to provide control functionality beyond the scope of the present disclosure. FIG. 2 provides more detail of a HVAC controller constructed according to the disclosure.

FIG. 2 illustrates a block diagram of an embodiment of an HVAC controller 200 constructed according to the principles of the disclosure. The controller 200 is configured to perform a self-check on operating units of the HVAC system and then operate the operating units in predetermined operating procedures based on feedback data from the self-check. The predetermined operating procedures are specifically associated with a particular operating unit. The controller 200 may perform the self-check at start-up and/or during operation of the HVAC system. The HVAC controller 200 includes an interface 210, an operation verifier 220 and a mode setter 230. At least a portion of the operation verifier 220 and/or the mode setter 230 may be implemented in a processor and/or a memory of the controller 200.

The interface 210 is configured to receive feedback data from operating units of an HVAC system and transmit control data to the operating units. The HVAC system may be, for example, the HVAC system 100 of FIG. 1 or the HVAC system 400 of FIG. 4. The interface 210 may be a conventional interface typically employed in HVAC controllers to receive and transmit data.

The operation verifier 220 is configured to determine an individual operating status for each one of the operating units of the HVAC system based on the feedback data. In one embodiment, the operation verifier 220 may be configured to determine the operating status of multiple operating units in a designated order. As such, knowledge obtained from already received feedback data of an operating unit or units may be employed to determine the operating status of another operating unit.

The operation verifier 220 is configured to determine each individual operating status based on designated operating parameters for each one of the operating units. In one embodiment, the operation verifier may be configured to determine the individual operating status for a particular one of the operating units based on feedback data from multiple of the operating units.

The mode setter 230 is configured to distinctly operate each one of the operating units in a predetermined operating procedure based on the determined operating status for each one of the operating units. In one embodiment, one or at least one of the operating units may have multiple predetermined operating procedures and the mode setter 230 is configured to select one of the multiple predetermined operating procedures for operation thereof. The mode setter 230 may select one of the predetermined operating procedures according to a severity level of the operating status. In another embodiment, multiple modes of operation may be included within a single predetermined operating procedure. For example, FIG. 8 illustrates a flow diagram of an embodiment of a method 800 of operating an HVAC system according with a predetermined operating procedure of an intake pressure sensor.

The mode setter 230 is configured to individually operate at least one of the operating units in a predetermined operating procedure based on the received feedback data. Of course, the mode setter 230 may be configured to operate multiple or all of the operating units according to predetermined operating procedures. While operating in a predetermined operating procedure, the mode setter 230 is further configured to monitor the operation of the operating unit and adjust the operation thereof based on the monitored feedback. In some embodiments, each predetermined operating procedure is designated to provide a pre-defined mode of operation that is adjustable according to the monitored feedback. Thus, the mode setter 230 may return the operating unit to normal operation while in the predetermined operating procedure. For example, the mode setter 230 may determine that the operating unit is now operating within an acceptable set of parameters and can be returned to normal operation. Additionally, the mode setter 230 may be configured to disable or alter the operation mode based on monitored feedback data received during the predetermined operating procedure. For example, operation of the operating unit may worsen while in the predetermined operating procedure to the point that the operating unit or even the HVAC system should be disabled or operated at a more cautious level. The mode setter 230 may monitor different types of data associated with the operating unit while in the predetermined operating procedure. Accordingly, a current, voltage, temperature, etc., of a single operating unit may be monitored and employed while in the predetermined operating procedure.

FIG. 3 illustrates a flow diagram of an embodiment of a method 300 of operating an HVAC system carried out according to the principles of the disclosure. The HVAC system may be a RTU that includes a refrigeration circuit, an indoor air blower system an outdoor fan system and a heating element. Additionally, the RTU may have an associated ERV. An HVAC controller such as described with respect to FIG. 1 or FIG. 2 may be used to perform the method 300. A portion of the method 300 may represent an algorithm that is stored on a computer readable medium, such as a memory of an HVAC controller (e.g., the memory 176 of FIG. 1) as a series of operating instructions that can direct the operation of a processor (e.g., the processor 174 of FIG. 1). The method 300 begins in a step 305.

In a step 310, feedback data is received from operating units of the HVAC system. The feedback data may be received, for example, over a wireless connection or a wired connection. A communications interface of a controller for the HVAC system may receive the feedback data. The feedback data includes operating information of the various operating units of the HVAC system. As such, the sensors and components of the HVAC system transmit real time operating information. The feedback data may be received automatically without prompting from the controller or may be received after a trigger signal is sent from the controller to each respective operating unit. The feedback data, or at least some of the feedback data, may be received at start-up of the HVAC system or start-up of at least a portion of the HVAC system. Additionally, the feedback data may be received during operation of the HVAC system or operation of at least a portion thereof. In some embodiments, the feedback data is received at predetermined times that can vary for the different operating units and may change for each operating unit during operation of the HVAC system. The predetermined times for the different operating units may be coordinated. As such, the controller may receive the feedback data from different operating units at different times during operation of the HVAC system.

An individual operating status for each one of the operating units is determined based on the feedback data in a step 320. In one embodiment, the operating status for multiple of the operating units may be determined in a designated order. For example, the operating status for pressure sensors may be determined first and then the operating status for components thereafter. Accordingly, a previously determined operating status for one operating unit may be employed to assist in determining an operating status for another operating unit.

Designated operating parameters may be employed to determine an operating status for the operating units. The designated operating parameters may be specifically established for each operating unit based on, for example, the HVAC system design, installation specifications or client preferences. Different levels of operating status for individual operating units can be established based on established ranges of the operating parameters for a particular operating unit. For example, a first range of parameters for a component may be established to correspond to a first operating status and a second range of parameters for the component may be established to correspond to a second operating status. In some embodiments, the individual operating status for a particular one of the operating units may be determined based on feedback data from multiple of the operating units.

In a step 330, each one of the operating units is distinctly operated in a predetermined operating procedure based on the determined operating status for each particular operating unit. At least one or even multiple of the operating units may have a predetermined operating procedure that includes multiple modes of operation that correspond to a severity level of an operating status. Determining the operating status and distinctly operating the operating units may be performed at start-up of the HVAC system. Determining the operating status and distinctly operating the operating units may also be performed during operation of the HVAC system.

Control data is transmitted to the operating units in a step 340 to direct the operation of the operating units in the predetermined operating procedure. The communications interface of the controller may be employed to transmit the control data. The method 300 ends in a step 350.

FIG. 4 illustrates a block diagram of an embodiment of an HVAC system 400 constructed according to principles of the disclosure. The system 400 includes an ERV 405 and an RTU 410. While the embodiment of the system 400 is discussed in the context of a RTU, the scope of the disclosure includes other HVAC applications that are not roof-top mounted.

The ERV 405 includes an enclosure (e.g. a cabinet) 412, first and second variable speed blowers 415 and 420, an enthalpy wheel 425 and a divider 430. The blowers 415, 420 may be of any conventional or novel type, such as radial or axial, impeller- or propeller-types. The blowers 415 and 420 as illustrated are configured in a pull-pull configuration, but embodiments of the system 400 are not limited thereto. The enthalpy wheel 425 may also be conventional or novel. Without limitation to any particular type of enthalpy wheel, those skilled in the pertinent art will appreciate that enthalpy wheels typically include a heat and/or moisture transfer medium that provides a semi-permeable barrier for air to flow there through.

In the illustrated embodiment the enthalpy wheel 425 and the divider 430 divide the ERV 405 into four zones, I, II, III and IV. The blower 415 operates to draw an airstream 435a from outside the enclosure 412 into zone I. The incoming air may be, for example, outside air. As used herein outside air is air that is initially external to the ERV 405 and an enclosed space (such as a building) that is environmentally conditioned by the system 400. The air stream 435a passes through the enthalpy wheel 425 and enters zone II. Air within zone II may exit the ERV 405 via an unreferenced outlet as an airstream 435b.

The ERV 405 receives an air stream 440a from the RTU 410 into zone III. The blower 420 draws the airstream 440a through the enthalpy wheel 425 to zone IV. The air exits zone IV via an unreferenced outlet.

In some embodiments the airstreams 435a,b and 440a,b all have about an equal flow rate, e.g., m³/minute. In some other embodiments the ERV 405 includes one or more bypass dampers 450 that provide a controllable path between one or more of the zones and the outside air. In such cases the air streams 435a,b and 440a,b may have different flow rates to reflect air that is drawn into or vented via the one or more dampers 450.

In the illustrated embodiment the ERV 405 is joined to the RTU 410 such that the ERV 405 provides the air stream 435b to an unreferenced intake of the RTU 410. The ERV 405 also receives the air stream 440a from the RTU 410 via an unreferenced exhaust outlet of the RTU 410.

The RTU 410 includes an economizer 455, a cooling element 460, a heating element 465 and a blower 470. The blower operates to force an air stream 475 into the building being conditioned via an unreferenced supply duct. A return airstream 480 from the building enters the RTU 410 at an unreferenced return duct.

A first portion 485 of the air stream 480 recirculates through the economizer 455 and joins the air stream 435b to provide supply air to the building. A second portion of the air stream 480 is the air stream 440a, which enters zone III of the ERV 405.

The economizer 455 may operate conventionally to vent a portion of the return air 480 and replace the vented portion with the air stream 435b. Thus air quality characteristics such as CO₂ concentration and humidity may be maintained within defined limits within the building being conditioned.

The controller 490 may be similarly configured as the controller 200 of FIG. 2. As such, the controller 490 includes an interface 492, an operation verifier 494 and a mode setter 496. The operation verifier 494 and the mode setter 496 may be implemented on a processor and a memory of the controller 490. The interface 492 receives feedback data from sensors and components of the system 400 and transmits control data thereto. As such, the controller 490 may receive feedback data from the pressure transducer 490 and the blowers 415, 420, and transmit control data thereto.

The interface 490 may be a conventional interface that employs a known protocol for communicating (i.e., transmitting and receiving) data. The interface 490 may be configured to receive both analog and digital data. The data may be received over wired, wireless or both types of communication mediums. In some embodiments, a communications bus may be employed to couple at least some of the various operating units to the interface 490.

The operation verifier 494 determines an individual operating status for the pressure transducer 490 and the blowers 415, 420 based on the feedback data. The mode setter 496 distinctly operates the pressure transducer 490 and the blowers 415, 420 in a predetermined operating procedure based on the determined operating status for the pressure transducer 490 and the blowers 415, 420. In one embodiment, a controller of the RTU 410 (not shown) may be configured to provide the self-check scheme functionality of the controller 490 for the operating units of the RTU.

The mode setter 496 is configured to individually operate at least one of the operating units of the ERV 405 in a predetermined operating procedure based on the feedback data. Each predetermined operating procedure is a predetermined operating process specifically configured to operate the ERV 405 or at least a portion of the ERV 405 at a limited capacity. A predetermined operating procedure may include monitoring of an associated operating unit and the ability to alter the operation mode of the ERV 405 feedback data obtained during the predetermined operating procedure monitoring. For example, a predetermined operating procedure may be entered for operating the enthalpy wheel 425 of FIG. 4. The predetermined operating procedure may have been activated due to the failure of a sensor to operate properly after a predetermined number of tries or is operating but is operating outside of a set of operating parameters. While in the designated predetermined operating procedure, the enthalpy wheel 425 may still be operated but at a reduced capacity. Advantageously, the predetermined operating procedure is a predetermined process that can allow a reduced operating capacity to obtain at least some benefit from the ERV 405 but yet still provide some protection for the ERV 405. An example of a particular predetermined operating procedure associated with an enthalpy wheel is provided in related application [LENX-100094]. Additionally, FIG. 8 illustrates a predetermined operating procedure associated with an intake pressure sensor. Designated predetermined operating procedures for other components of the ERV 405, such as the blowers 415, 420, may be stored on a memory of the controller 490 and can be accessed by a processor thereof for implementation.

FIG. 5A and FIG. 5B illustrate a flow diagram of an embodiment of a method 500 of operating a particular HVAC system, an ERV, carried out according to the principles of the disclosure. The method 500 applies to an ERV having two enthalpy wheels. One skilled in the art will understand that the method 500 may similarly be used for an ERV having a different number of enthalpy wheels than two. For example, the method may be similarly used with the ERV 405 of FIG. 4. The method 500 may operate the HVAC system in various predetermined operating procedures based on feedback data. The method begins in a step 505.

In a step 510, the ERV is operated in an idle mode. In the idle mode, the ERV has power but has not received a signal to initiate operation (i.e., a “call to use” signal). In a first decisional step 515 a determination is made if the ERV has received a call to use (i.e., is the ERV occupied). If not, the method continues to step 510 and remains in idle mode. If so, the ERV is turned-on and the method 500 continues to second decisional step 520 where a determination is made if a free cooling mode has been indicated. An RTU associated with the ERV, such as the RTU 410 of FIG. 4, may indicate the free cooling mode to the ERV. In the free cooling mode, the ERV is not activated.

Returning now to the second decisional step 520, if the free cooling mode is active, the method proceeds to step 522 and the ERV is operated in free cooling mode wherein the ERV is not operated. As such, the method 500 proceeds to step 515 from step 522. If the free cooling mode is not active, the method 500 continues to a third decisional step 525 where a determination is made if the sensors of the ERV are operating properly. Feedback data from the sensors may be used to determine the operating status of the sensors. In one embodiment, a continuity check of the sensors may be performed. For example, a pressure sensor may be designed to provide an operating signal within 4.5 mA to 5.5 mA when connected properly (e.g., plugged in). The feedback data from the pressure sensor may be compared to the predetermined set of parameters to verify continuity. Additionally, a determination may be made if the sensors are reading within a given range. For example, if a temperature sensor, a determination may be made to verify that the temperature being read by the sensor is within an expected temperature range. The temperature range may be based on estimated operating conditions.

If a sensor is not operating properly, the failed sensor or sensors are operated in a predetermined operating procedure in a step 527 based on the feedback data. The predetermined operating procedure may operate the sensor at a reduced capacity or deactivate the sensor.

After determining the operating status of the sensors, the method 500 proceeds to fourth decisional step 530 where a determination is made if the outside air temperature (OAT) is less than or equal to a predetermined maximum temperature. If so, the ERV is operated at a predetermined operating procedure based on the maximum temperature in a step 532.

If the outside air temperature is less than or equal to a predetermined maximum temperature, a determination is then made in a fifth decisional step 535 if the outside air temperature is less than a predetermined minimum temperature. If not, then the ERV is operated in a predetermined operating procedure based on the minimum temperature in a step 537. The predetermined minimum and maximum temperatures may be based on estimated operating conditions or historical data associated with the type of HVAC system.

If the outside air temperature is less than a predetermined minimum temperature, the method 500 proceeds to step 540 where the intake blower of the ERV is operated at a predetermined set point. The intake and the exhaust blower of the ERV are monitored in a step 545. The blowers may be monitored based on feedback data obtained through an operating bus of the ERV. For example, a bus, such as a Modbus, may be used to communicate data from the components and/or sensors of the ERV. As such, the feedback data from the blowers may be communicated via a bus protocol to the controller. By employing a bus for communication, various types of feedback data may be communicated to the controller for the blowers, such as, voltage, current, speed, temperature, etc.

A determination is then made in a sixth decisional step 550 if the intake and exhaust blowers are operating properly. The determination may be made by comparing the feedback data from the blowers to predetermined operating parameters for the blowers. If the blowers are operating properly, e.g., within the predetermined operating parameters, then the method proceeds to step 555 where intake pressure of the enthalpy wheel is monitored. If the blowers are not operating properly, the blowers or blower are operated in a predetermined mode in a step 552.

Proceeding now to FIG. 5B, while monitoring the wheel intake pressure, a determination is then made in a seventh decisional step 560 if the wheel intake pressure (Pwheel) is greater than a predetermined maximum pressure (PwheelMax). If so, the enthalpy wheel is operated at a predetermined operating procedure in a step 562. In this embodiment, the predetermined operating procedure corresponds to a blocked or frosted wheel mode. The blocked or frosted wheel mode may correspond to similarly named modes disclosed in related Patent Application No. [LENX-100094].

If the wheel intake pressure is not greater than the predetermined maximum pressure, an intake and exhaust pressure of the ERV is determined in a step 565. Pressure sensors may be used to determine the intake and exhaust CFM. The controller may receive the operating pressures.

In an eighth decisional step 570, a determination is made if the difference between the outside air temperature (OAT) minus the return air temperature (RAT) is greater than a predetermined effective temperature for the ERV. The predetermined effective temperature is set as a deciding point to determine if operating the ERV would be effective or not. If not, the ERV is operated in a non-effective mode in a step 572. If it is determined that operation of the ERV can be effective, then the enthalpy wheels are enabled in a step 575. The start-up time for the wheels is then delayed in a step 580. The delay for starting may depend on the time needed to reach a designated set point. In some embodiments, the start-up time may be thirty seconds.

The actual enthalpy (Eactual or Eact) is calculated in a step 585. Conventional calculations may be employed to determine the actual enthalpy for the ERV. In a step 590, enthalpy references values are obtained. The reference values may be stored in a lookup table, such as in a memory associated with the controller of the ERV. Various operating modes may then be determined based on comparison between the actual and reference enthalpy.

In a step 592, the actual enthalpy is compared to the reference enthalpy (Eref) to determine if the actual enthalpy is greater than or equal to the reference enthalpy. If greater, the ERV is operated at a steady state in a step 593. The steady state of the ERV occurs when the ERV is in an energy recovery mode, or operating normally with no alarms. If the actual enthalpy is not greater than or equal to the reference enthalpy, then in a tenth decisional step 594 another determination is made to see if Reff is less than Rmin2w. If not the method 500 continues to step 593. If so, the method continues to an eleventh decisional step 596 where a determination is made if Reff is greater than Rmin1w. If not, the ERV is operated in a predetermined operating procedure in a step 597 wherein a single enthalpy wheel is activated. If so, then the ERV is operated in a predetermined operating procedure in a step 599 wherein no enthalpy wheels are activated.

Operation of the ERV continues in the various predetermined operating procedures according to the method 500 based on the feedback data. Some of the predetermined operating procedures may correspond to the particular operating modes defined in the noted related applications. For example, the predetermined operating procedure associated with step 562 may correspond to an operating mode defined in Patent Application No. [LENX-100094].

FIG. 6 illustrates a flow diagram of another embodiment of a method 600 of operating an HVAC system carried out according to the principles of the disclosure. As mentioned above, the HVAC unit may be an RTU or an ERV. An HVAC controller such as described with respect to FIG. 1, FIG. 2 or FIG. 4 may be used to perform the method 600. A portion of the method 600 may represent an algorithm that is stored on a computer readable medium, such as a memory of an HVAC controller (e.g., the memory 196 of FIG. 1) as a series of operating instructions that can direct the operation of a processor (e.g., the processor 194 of FIG. 1). The method 600 begins in a step 605.

In a step 610, feedback data is received from operating units of the HVAC system. The feedback data may be received, for example, over a wireless connection or a wired connection. A communications interface of a controller for the HVAC system may receive the feedback data. The feedback data includes operating information of the various operating units of the HVAC system. As such, the sensors and components of the HVAC system transmit real time operating information. The feedback data may include both analog and digital data. The feedback data may be received automatically without prompting from the controller or may be received after a trigger signal is sent from the controller to each respective operating unit.

The feedback data may be received at start-up of the HVAC system or at least a portion thereof. Additionally, the feedback data may be received during operation of the HVAC system or during operation of a portion thereof. In some embodiments, the feedback data is received at predetermined times that can vary for the different operating units. As such, the controller may receive the feedback data from different operating units at different times during operation of the HVAC system. Furthermore, the feedback data may be received in a predetermined order controlled by the controller.

At least one of the operating units is individually operated in a predetermined operating procedure based on the feedback data in a step 620. Each predetermined operating procedure is a predetermined operating process specifically configured to operate at least one of the operating units in a limited capacity. Depending on the feedback data, multiple operating units or even the HVAC system itself may be placed in a predetermined operating procedure.

In a step 630, operation of the operating unit is monitored while in the predetermined operating procedure. Based on the feedback obtained while in the predetermined operating procedure, the operating unit may be operated at normal operation based on the feedback data received. For example, the operating unit may be returned to normal operation in response to changes in the feedback data. As such, the operating unit may be moved out of predetermined operating procedure operation to normal operation.

Alternatively, the feedback data obtained during predetermined operating procedure may result in disabling operation of the operation unit. For example, the operating unit may be a motor that is approaching complete failure according to the predetermined operating procedure feedback data. As such, to protect the motor and other operating units of the HVAC system, the motor may be disabled.

Different types of feedback data may be monitored during the predetermined operating procedure. In some embodiments multiple parameters may be used to provide feedback data for a single operating unit. For example, a blower may provide feedback data in the form of diagnostics including error codes, voltage, current, speed and temperature. In addition to these being monitored during predetermined operating procedure, these types of diagnostics may also be used as feedback data to trigger a predetermined operating procedure if these should indicate a failure or fall outside of a set parameters.

Operation of the operating unit is adjusted in a step 640 while in the predetermined operating procedure. The predetermined operating procedure feedback data may indicate to adjust the operation of an operating unit. For example, the feedback data may indicate that a condition associated with an operating unit has worsened and a more restrictive level of operation is needed. As such, alarm limits may be adjusted to become more sensitive and provide more protection for the operating unit. One skilled in the art will understand that operation of the operating unit may also be adjusted due to improved conditions of the operating unit. Accordingly, the operating capacity of the operating unit may be increased during the predetermined operating procedure. In a step 640, the method 600 ends.

FIG. 7 illustrates an embodiment of a Table 700 including the various feedback data that is communicated by a controller constructed according to the principles of the disclosure. The controller may be the controller of FIG. 1, FIG. 2 or FIG. 4. The feedback data and control signals may be communicated via an interface of the controller, such as the interface of FIG. 1, FIG. 2 or FIG. 4. Each of the inputs/outputs of Table 700 may have an associated predetermined operating procedure that can be entered upon failure or operation outside a defined set of parameters.

Table 700 includes three columns. The first column lists the various inputs and outputs. The second column provides a description of the input or output and the third column lists the value of the particular input or output. Table 700 is provided as an example and the feedback data and control signals thereof relate to a specific HVAC unit. One skilled in the art will understand that other data tables may be employed for other HVAC units.

In the first column, the input and outputs are designated as either analog or digital signals based on the first letter. A is used to represent an analog signal and D is used to represent a digital signal. The second letter of the designated input or output signals indicates if the signal is an input to the controller or an output from the controller. The third position of each designation in the first column is a number that is used to identify and keep track of the signals. For example, “AI1” in row one is designated the first analog input signal and “DO8” in the last row of the first column is designated the eighth digital output signal from the controller.

In some embodiments, various operating units, such as blowers, are coupled to the controller via a bus that provides a network connection between the controller and blowers. A Modbus connection, for example, may be employed. Modbus is a serial communications protocol well known in the art. The controller may also be connected to a network that allows reporting the status of some operating units to a client. In some embodiments, the controller may be coupled to an existing network via another controller. For example, the controller 490 of the ERV 405 may be coupled to a controller of the RTU 410 via a UBS compliant connection. The RTU 410 controller may forward reporting data to a client via a wireless or wired network.

FIG. 8 illustrates a flow diagram of an embodiment of a method 800 of operating an HVAC system according to a predetermined operating procedure carried out according to the principles of the disclosure. The method 800 provides a single example of a predetermined operating procedure (or safe mode) of the many such procedures that may be associated with an HVAC system. The HVAC system represented in the method 800 is an ERV such as the ERV 405 of FIG. 4. The disclosed predetermined operating procedure is specifically designated for the operation of an intake pressure sensor. A determination to enter the designated predetermined operating procedure for the intake pressure sensor is based on the status of feedback signal AI2. If AI2 is lost, the disclosed predetermined operating procedure tries to avoid turning off a portion of the ERV, or the ERV itself, without damaging the ERV. As such, the predetermined operating procedure represented in FIG. 8 steps down the performance of the ERV to provide some advantage to the client or consumer without damaging the ERV equipment. The method 800 starts in a step 505 with monitoring of the intake pressure of the enthalpy wheel. As noted in Table 700, the signal AI2 is used to monitor the intake pressure of the enthalpy wheel.

In a first decisional step 810, a determination is made if the signal AI2 is being received. If not, the method 800 continues to step 820 where an alarm is initiated. The alarm may be transmitted to a client monitoring station and/or may be indicated on a board of the controller via, for example, an LED. After initiating the alarm, the predetermined operating procedure for the AI2 signal is enabled in a step 830.

In a second decisional step 840, a determination is then made in the predetermined operating procedure if the intake CFM sensor is operating properly (e.g., plugged in and generating a signal within a predefined range). As noted in Table 400, the signal AI5 is used to monitor the intake CFM sensor. If the intake CFM sensor is operating properly, the AI5 signal is used for all CFM measurements by the ERV in a step 850. As such, the value of AI5 simply replaces AI1 where used. The method 800 then continues to step 860 where start-up or the steady state of the ERV continues. In the start-up or steady state of the ERV, the AI5 signal will be used for the CFM measurements. After step 860, the method 800 continues to step 805 where monitoring of the AI2 signal continues.

Returning now to the second decisional step 840, if AI5 is not operating properly, the last known value for CFM is used in a step 842. The HVAC system may accomplish this by comparing the Modbus values for the intake blower prior to the failure of the AI1 to the current values and adjust accordingly. Thereafter, the start-up or steady state of the ERV is continued in a step 846 employing the last known CFM value. The method 800 then continues to step 805.

Returning now to first decisional step 810, if the AI2 signal is being received, then a determination is made in a third decisional step 812 if AI2 actual is greater than a predetermined minimum value for AI2. If so, the start-up or the steady state of the ERV continues in a step 814 and the predetermined operating procedure is not entered.

If AI2 actual is not greater than the AI2 maximum value, then a determination is made in a fourth decisional step 816 if enthalpy wheel is frosted or blocked. The AI2 maximum value may be predetermined based on the HVAC system and loaded into the controller. If so, a defrost mode is entered in a step 818. The method 800 then proceeds to step 805 for additional monitoring of AI2.

If the enthalpy wheel is not blocked, the method continues to step 820 where an alarm is initiated and the predetermined operating procedure will then be entered. Thus, even if the AI2 signal is present, the predetermined operating procedure may still be entered.

The above-described methods or at least portions thereof may be embodied in or performed by various conventional digital data processors, microprocessors or computing devices, wherein these devices are programmed or store executable programs of sequences of software instructions to perform one or more of the steps of the methods, e.g., steps of the method of FIG. 3, FIG. 5 or FIG. 8. The software instructions of such programs may represent algorithms and be encoded in machine-executable form on conventional digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods. Accordingly, computer storage products with a computer-readable medium, such as a non-transitory computer-readable medium, that have program code thereon for performing various computer-implemented operations that embody the tools or carry out the steps of the methods set forth herein may be employed. A non-transitory media includes all computer-readable or computer-usable media except for a transitory, propagating signal. The media and program code may be specially designed and constructed for the purposes of the disclosure, or they may be of the kind well known and available to those having skill in the computer software arts. Additionally, an apparatus, such as dedicated HVAC controller or, more specifically, an ERV controller, may be designed to include the necessary circuitry to perform or direct the performance or steps of the methods of FIG. 3, FIG. 5 or FIG. 8.

The above-described methods or at least portions thereof may be embodied in or performed by various conventional digital data processors, microprocessors or computing devices, wherein these devices are programmed or store executable programs of sequences of software instructions to perform one or more of the steps of the methods, e.g., steps of the method of FIG. 3, FIG. 5 or FIG. 8. The software instructions of such programs may represent algorithms and be encoded in machine-executable form on conventional digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods. Accordingly, computer storage products with a computer-readable medium, such as a non-transitory computer-readable medium, that have program code thereon for performing various computer-implemented operations that embody the tools or carry out the steps of the methods set forth herein may be employed. A non-transitory media includes all computer-readable or computer-usable media except for a transitory, propagating signal. The media and program code may be specially designed and constructed for the purposes of the disclosure, or they may be of the kind well known and available to those having skill in the computer software arts. Additionally, an apparatus, such as dedicated HVAC controller or, more specifically, an ERV controller, may be designed to include the necessary circuitry to perform or direct the performance or steps of the methods of FIG. 3, FIG. 5 or FIG. 8.

Those skilled in the art to which this application relates will appreciate that other and further additions, deletions, substitutions and modifications may be made to the described embodiments.

What is claimed is:

1. A controller for a heating, ventilating and cooling (HVAC) system, comprising:
an interface configured to receive feedback data from operating units of said HVAC system and transmit control data to said operating units;
an operation verifier configured to determine an individual operating status for each one of said operating units based on said feedback data; and
a mode setter configured to distinctly operate said each one in a predetermined operating procedure based on said determined operating status for said each one.

2. The controller as recited in claim 1 wherein said operation verifier is configured to determine multiple operating statuses in a designated order.

3. The controller as recited in claim 1 wherein said operation verifier is configured to determine each said individual operating status based on designated operating parameters for said each one.

4. The controller as recited in claim 1 wherein said operation verifier is configured to determine said individual operating status for a particular one of said operating units based on feedback data from multiple of said operating units.

5. The controller as recited in claim 1 wherein said operation verifier is configured to determine each said operation status at start-up of said HVAC system.

6. A computer-usable medium having non-transitory computer readable instructions stored thereon for execution by a processor to perform a method for operating a heating, ventilating and cooling (HVAC) system, comprising:
receiving feedback data from operating units of said HVAC system;
determining an individual operating status for each one of said operating units based on said feedback data; and
distinctly operating said each one in a predetermined operating procedure based on said determined operating status for said each one.

7. The computer-usable medium as recited in claim 8 wherein said determining includes determining multiple operating statuses in a designated order.

8. The computer-usable medium as recited in claim 6 wherein said determining is based on designated operating parameters for said each one of said operating units.

9. The computer-usable medium as recited in claim 6 wherein said determining includes determining said individual operating status for a particular one of said operating units based on feedback data from multiple of said operating units.

10. The computer-usable medium as recited in claim 6 wherein said determining and distinctly operating are performed during operation of said HVAC system.

11. A heating, ventilating and cooling (HVAC) system, comprising:
sensors configured to indicate operating conditions of said HVAC system;
multiple components configured to condition and move air through said HVAC system; and
a controller including:
an interface configured to receive feedback data from said sensors and said multiple components and transmit control data to said multiple components;
an operation verifier configured to determine an individual operating status for each one of said sensors and said multiple components based on said feedback data; and
a mode setter configured to distinctly operate said each one in a predetermined operating procedure based on each said determined operating status.

12. The HVAC system as recited in claim 11 wherein said HVAC system is an energy recovery system and said multiple components include an intake blower and an enthalpy wheel.

13. The HVAC system as recited in claim 11 wherein said operation verifier is configured to determine each said individual operating status based on designated operating parameters for said each one.

14. The HVAC system as recited in claim 11 wherein said operation verifier is configured to determine said individual operating status for a particular one of said sensors and said multiple components based on feedback data from multiple of said sensors and said multiple components.

15. The HVAC system as recited in claim 11 wherein said operation verifier is configured to determine each said operation status at start-up of said HVAC system.

16. A controller for a heating, ventilating and cooling (HVAC) system, comprising:
an interface configured to receive feedback data from operating units of said HVAC system and transmit control data to said operating units; and
an mode setter configured to individually operate at least one of said operating units in a predetermined operating procedure based on said feedback data, wherein each said predetermined operating procedure is an operating process specifically configured to operate said at least one at a reduced capacity.

17. The controller as recited in claim 16 wherein said mode setter is configured to monitor operation of said at least one operating unit while in said predetermined operating procedure.

18. The controller as recited in claim 17 wherein said mode setter is configured to operate said at least one operating unit at normal operation or disable operation of said at least one operating unit based on said feedback data received during said predetermined operating procedure.

19. The controller as recited in claim 17 wherein said mode setter is configured to alter operation of said at least one operating unit based on said feedback data received during said predetermined operating procedure.

20. A computer-usable medium having non-transitory computer readable instructions stored thereon for execution by a processor to perform a method for operating a heating, ventilating and cooling (HVAC) system, comprising:
receiving feedback data from operating units of said HVAC system; and
individually operating at least one of said operating units in a predetermined operating procedure based on said feedback data, wherein each said predetermined operating procedure is an operating process specifically configured to operate said at least one in a limited capacity.

21. The computer-usable medium as recited in claim 20 further comprising monitoring operation of said at least one operating unit while in said predetermined operating procedure.

22. The computer-usable medium as recited in claim 21 further comprising altering operation of said at least one operating unit based on said feedback data received during said predetermined operating procedure.

23. The computer-usable medium as recited in claim 21 wherein said monitoring includes monitoring different types of feedback data during said predetermined operating procedure.

24. A heating, ventilating and cooling (HVAC) system, comprising:
sensors configured to indicate operating conditions of said HVAC system;
multiple components configured to condition and move air through said HVAC system; and
a controller including:
an interface configured to receive feedback data from operating units of said HVAC system and transmit control data to said operating units; and
an mode setter configured to individually operate at least one of said operating units in a predetermined operating procedure based on said feedback data, wherein each said predetermined operating procedure is a predetermined operating process specifically configured to operate said at least one in a limited capacity.

25. The HVAC system as recited in claim 24 wherein said mode setter is configured to monitor operation of said at least one operating unit while in said predetermined operating procedure and alter operation of said at least one operating unit based on said feedback data received during said predetermined operating procedure.

26. The HVAC system as recited in claim 24 wherein said mode setter is configured to monitor different types of feedback data during said predetermined operating procedure.
